(19) United States
(12) Patent Application Publication
(10) Pub. No.: US 2007/0032302 A1
(43) Pub. Date: Feb. 8, 2007

(54) Centering sleeve

(76) Inventors: Andreas Mahling, Meckenbeuren (DE); Hans Roth, Salem (DE)

Correspondence Address: Klaus P. Stoffel;Wolff & Samson PC, One Boland Drive, West Orange, NJ, 07052, US

(21) Appl. No.: 11/499,992

(22) Filed: Aug. 7, 2006

(30) Foreign Application Priority Data
Aug. 6, 2005 (DE) 10 2005 037 135.3

(51) Int. Cl. F16D 3/00

(52) U.S. Cl. 464/89

(57) ABSTRACT

A centering sleeve of a propeller shaft designed to receive a gearbox pin and having a tube and a rubber body. The tube has a first section of larger outside diameter, a second section of smaller outside diameter, and a connecting area of increased radial stiffness, which connects the two sections integrally to each other.

### BACKGROUND OF THE INVENTION

The invention pertains to a centering sleeve of a propeller shaft designed to receive a gearbox pin and consisting of a tube and a rubber body, which is installed inside the tube and supports the gearbox pin in the centering sleeve.

In a motor vehicle, the output torque present at a gearbox takeoff is transmitted to an axle power divider. The propeller shaft consists of a hollow pipe with a 3-arm flange at each end. On the gearbox side, the propeller shaft is screwed by way of this 3-arm flange to a corresponding opposing piece on the gearbox takeoff shaft. Inside the 3-arm flange, a centering sleeve is provided, by means of which the propeller shaft is centered on a gearbox pin of the gearbox takeoff shaft.

A propeller shaft with a 3-arm flange and an inserted centering sleeve is known from DE 25 34 684 A1. A rubber body is installed inside the centering sleeve to damp vibrations and to compensate for any lateral offset there might be between the propeller shaft and the gearbox pin. Because of the softness of the centering, however, this arrangement tends to go out of balance.

An improved propeller shaft is known from DE 32 45 041 C2, in which a metal bush is inserted inside the rubber body. This bush gives the rubber body a harder spring characteristic, so that the arrangement shows less of a tendency to go out of balance. The centering sleeve is produced by a series of three steps. In the first step, the tube is prepared, and in the second step, the bush is produced. Then, in the third step, the bush with the rubber body is vulcanized inside the tube. This propeller shaft has proven reliable in practice, but it is not satisfactory from the standpoint of production cost.

### SUMMARY OF THE INVENTION

The invention is therefore based on the task of providing an elastically stiff centering sleeve according to an optimized production method.

In the inventive centering sleeve, the surrounding tube has a first section of larger outside diameter, a second section of smaller outside diameter, and a connecting area of increased radial stiffness, which connects the two sections integrally together. In one embodiment of the invention the connecting area is created by folding the tube, so that the second section is located inside the first section. The second section of the tube is therefore located inside the outside diameter of the first section. In an alternative embodiment, the connecting area is formed by graduating the tube, so that the first section and the second section abut each other in the axial direction. In both embodiments, an increased radial stiffness is achieved in that the wall thickness of the connecting area in the radial direction is greater than that of the wall of the tube. Common to both embodiments is that the rubber body is vulcanized into the interior of the smaller outside diameter of the second section.

The centering sleeve is produced in two steps. In the first step, the first and the second sections of the tube are produced by forming, and in the second step the rubber body is vulcanized inside the tube.

The advantages of the invention are that, for a spring characteristic identical to that of the state of the art, the bush can be eliminated and the rubber body is made with a smaller volume. The result is a lower-cost production method and reduced component cost. For a given outside diameter, the desired spring stiffness can be obtained by appropriate selection of the wall thickness in the connecting area.

Further advantages, features and details of the invention are revealed in the following description of preferred exemplified embodiments and with the aid of the drawings

### BRIEF DESCRIPTION OF THE DRAWINGS

The drawings show preferred exemplary embodiments:

FIG. 1 shows a first embodiment of the centering sleeve; and

FIG. 2 shows a second embodiment of the centering sleeve.

### DESCRIPTION OF THE INVENTION

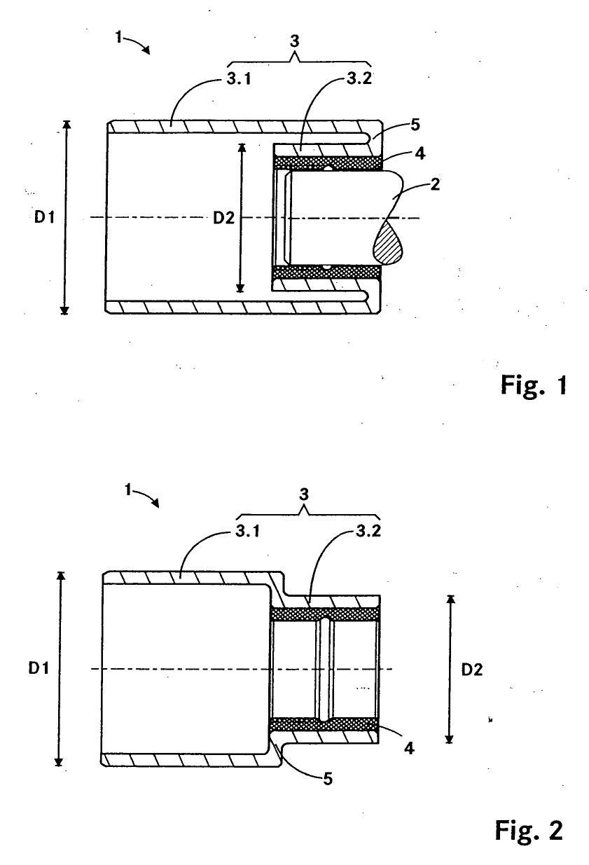

FIG. 1 shows a first embodiment of a centering sleeve 1. The centering sleeve 1 includes a tube 3, which has a first section 3.1 and a second section 3.2. The first section 3.1 has a larger outside diameter D1. The second section 3.2 has a smaller outside diameter D2. The first section 3.1 and the second section 3.2 of the tube 3 are connected integrally to each other by way of a connecting area 5. A rubber body 4 is vulcanized inside the second section 3.2. A propeller shaft is centered on a gearbox pin 2 by the tube 3 and the rubber body 4.

The centering sleeve 1 according to FIG. 1 is produced in two steps. In the first step, the tube 3 is shaped by a folding operation, so that the second section 3.2 becomes located inside the first section 3.1. In the second step, the rubber body 4 is then vulcanized in place. Because of the fold, the wall thickness of the connecting area 5 is increased in the radial direction, and the area therefore has increased radial stiffness.

FIG. 2 shows a second embodiment of the centering sleeve 1. In this embodiment, the connecting area 5 between the first section 3.1 and the second section 3.2 of the tube 3 is produced by means of a graduation, so that the first section 3.1 and the second section 3.2 abut each other in the axial direction. The increased radial stiffness is obtained here as well as a result of the increased wall thickness in the connecting area 5.

The rubber body 4 is placed inside the second section 3.2 to damp vibrations. The production method for this embodiment also consists of two steps. In the first step, the tube 3 is stepped down in the connecting area, and in the second step the rubber body 4 is vulcanized inside the second section 3.2.

In comparison with the state of the art, the invention offers the following advantages:
since only two steps are required, production costs are low;
the spring characteristic obtained by the folding step is nearly identical to that according to the state of the art; and
the costs of the parts are reduced even more by the elimination of the bush and by the smaller volume of the rubber body.

Although the present invention has been described in relation to particular embodiments thereof, many other variations and modifications and other uses will become more apparent to those skilled in the art. It is preferred, therefore, that the present invention be limited not by the specific disclosure herein, but only by the appended claims.

1. A centering sleeve for a propeller shaft designed to receive a gearbox pin, the centering sleeve comprising: a tube; and a rubber body which is located inside the tube and supports the gearbox pin in the centering sleeve, the tube having a first section with an outside diameter, a second section with an outside diameter smaller than the outside diameter of the first section, and a connecting area of increased radial stiffness, which connects the first and second sections integrally to each other.

2. The centering sleeve according to claim 1, wherein the connecting area is a folded portion of the tube whereby the second section is located inside the first section.

3. The centering sleeve according to claim 1, wherein the connecting area is a graduated portion of the tube whereby the first section and the second section abut each other in an axial direction.

4. The centering sleeve according to claim 1, wherein the rubber body is located inside the second section.

5. The centering sleeve according to claim 2, wherein the rubber body is located inside the second section.

6. The centering sleeve according to claim 3, wherein the rubber body is located inside the second section.

7. The centering sleeve according to claim 2, wherein the tube has a wall thickness in the connecting area that is greater than a wall thickness in the first and second sections.

8. The centering sleeve according to claim 3, wherein the tube has a wall thickness in the connecting area that is greater than a wall thickness in the first and second sections.
